(19) United States
(12) Patent Application Publication
(10) Pub. No.: US 2024/0139658 A1
(43) Pub. Date: May 2, 2024

(54) FLOW CONTROL DEVICE FOR FLUID FILTERING ASSEMBLY

(71) Applicant: GRAYL Inc., Seattle, WA (US)

(72) Inventors: Travis Merrigan, Bremerton, WA (US); Patrick Crosby, Terrell, NC (US); Scott Rolfson, Portland, OR (US); Andrew Weber, Seattle, WA (US); Christopher Leiter, Happy Valley, OR (US)

(21) Appl. No.: 18/382,983

(22) Filed: Oct. 23, 2023

Related U.S. Application Data
(60) Provisional application No. 63/420,003, filed on Oct. 27, 2022.

(51) Int. Cl. B01D 29/96; B01D 29/11

(52) U.S. Cl. CPC B01D 29/96; B01D 29/114; B01D 2201/02

(57) ABSTRACT

Embodiments are directed to filtration container assemblies and methods of using the same. A filtration container assembly can include an outer container and a plunging assembly. The outer container can have a first open end and a second closed end that defines an inner cavity. The plunging assembly can include a first end and a second end, with the second end of the plunging assembly being configured to be received within the inner cavity of the outer container. The plunging assembly can also include an inner sleeve having a first end and a second end and an outer wall that defines an inner bore. The plunging assembly can further include a filtration assembly in fluid communication with the inner bore, with the filtration assembly including a flow control device.

### CROSS-REFERENCE TO RELATED APPLICATIONS

The present application claims priority to U.S. Provisional Patent Application No. 63/420,003 filed Oct. 27, 2022, entitled “FLOW CONTROL DEVICE FOR FLUID FILTERING ASSEMBLY” the disclosure of which is hereby expressly incorporated by reference herein in its entirety.

### BACKGROUND

Some people prefer to filter tap water to remove unwanted impurities, tastes, heavy metals, and other toxins. Moreover, when collecting water from a natural, untreated source, such as a lake or a stream, or when traveling in a foreign country that does not treat its tap water, it is important to either filter or treat water for microbial contamination.

Tap water is currently filtered using several different kinds of filtering systems, for example, faucet attachments, refrigerator filter systems, or pitcher or basin-type drip filtration system, from which a user may pour filtered water from the filter systems into his or her cup. Natural, untreated water is typically filtered using a hand-held, filter pump that typically uses vacuum pressure to draw water into the filter. Improved filter assemblies using positive pressure are desirable because drip filtering processes can take a long time and vacuum filtering processes can be hard work for the user.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment of the present disclosure, a filtration container assembly is provided. The filtration assembly can include an outer container having a first open end and a second closed end and defining an inner cavity; and a plunging assembly having a first end and a second end, wherein the second end of the plunging assembly is configured to be received within the inner cavity of the outer container, wherein the plunging assembly includes an inner sleeve having a first end and a second end and an outer wall defining an inner bore, and a filtration assembly in fluid communication with the inner bore, the filtration assembly including a flow control device at or near an outlet of the filtration assembly.

In another embodiment of the present disclosure, a filter assembly for a filtration container assembly is provided. The filter assembly can include a filter housing having a first wall and a second wall radially inward of the first wall, the second wall defining a cavity at the center of the filter assembly; a filter media disposed within the housing, the filter media being configured to filter a fluid flowing through the filter media, wherein, at a first pressure, the fluid will flow through the filter media at a first flow rate; and a flow control device coupled to the filter housing such that the flow control device is disposed within the cavity defined by the inner wall of the filter housing, wherein the flow control device is configured to limit the direction the fluid can flow, wherein, at the first pressure, the fluid can flow through the flow control device at a second flow rate, and wherein the second flow rate is substantially equal to, or greater than, the first flow rate.

In another embodiment of the present disclosure, a method of filtering a liquid using a filtration container assembly is provided. The method can include obtaining a filtration container assembly including an outer container having a first open end and a second closed end and defining an inner cavity, and a plunging assembly having a first end and a second end, wherein the second end of the plunging assembly is configured to be received within the inner cavity of the outer container, wherein the first end of the plunging assembly includes a cap having a pressing surface configured for a user to press the plunging assembly into the inner cavity of the outer container, and wherein the plunging assembly includes a filtration assembly having a flow control device disposed within a cavity within the filtration assembly; filling the outer container with a liquid to equal to or less than a fill indicator; inserting the second end of the plunging assembly into the first open end of the outer container; and pressing the first pressing surface of the plunging assembly to press the plunging assembly into the inner cavity of the outer container.

In any of the embodiments described herein, the outer wall may be continuous from the first end to the second end of the inner sleeve.

In any of the embodiments described herein, the filtration assembly includes a first end and a second end, wherein the first end of the filtration assembly is at or near the second end of the inner sleeve.

In any of the embodiments described herein, the first end of the filtration assembly may be mechanically coupled to the inner sleeve at or near the second end of the inner sleeve.

In any of the embodiments described herein, the second end of the filtration assembly may be outside the inner bore of the inner sleeve.

In any of the embodiments described herein, the plunging assembly may be configured to filter a liquid contained in the outer container as the plunging assembly is pressed into the inner cavity of the outer container and the liquid moves from the inner cavity of the outer container through the filtration assembly to the inner bore of the inner sleeve of the plunging assembly.

In any of the embodiments described herein, the filtration assembly may define a filter housing between the first and second ends of the filtration assembly, the filter housing having a first wall defining a fluid inlet and a second wall defining a fluid outlet.

In any of the embodiments described herein, the first wall may include a plurality of apertures defining the fluid inlet.

In any of the embodiments described herein, filter media may be disposed within the filter housing.

In any of the embodiments described herein, the filter media may have a circular cross-section, and wherein the first wall is an outer wall and the second wall is an inner wall.

In any of the embodiments described herein, liquid may be configured to flow from the inlet through the filter media to a cavity of the filtration assembly.

In any of the embodiments described herein, the inner wall may define a cavity within the filtration assembly.

In any of the embodiments described herein, the cavity may be defined at the radial center of the filtration assembly.

In any of the embodiments described herein, the flow control device may be disposed within the cavity.

In any of the embodiments described herein, the flow control device may be configured to restrict liquid held within the inner bore from flowing through the filtration assembly.

In any of the embodiments described herein, the flow control device may include one or more sealing portions, the one or more sealing portions configured to couple to the filter housing and form a seal between the flow control device and the filter housing.

In any of the embodiments described herein, at least a portion of the flow control device may contact the inner wall of the filter housing.

In any of the embodiments described herein, the flow control device may include an end portion, and wherein the end portion may be coupled to the second end of the filtration assembly.

### BRIEF DESCRIPTION OF THE SEVERAL VIEWS OF THE DRAWINGS

The foregoing aspects and many of the attendant advantages of this disclosure will become more readily appreciated as the same become better understood by reference to the following detailed description, when taken in conjunction with the accompanying drawings.

FIG. 1A illustrates a perspective view of a filtration container assembly in accordance with one embodiment of the present disclosure.

FIG. 1B illustrates a top exploded view of the filtration container assembly of FIG. 1A.

FIG. 1C illustrates a bottom exploded view of the filtration container assembly of FIG. 1A.

FIG. 1D illustrates a cross-sectional view of the filtration container assembly of FIG. 1A.

FIG. 2A illustrates a perspective view of a flow control device in accordance with one embodiment of the present disclosure.

FIG. 2B illustrates a front view of the flow control device of FIG. 2A.

FIG. 3A illustrates a perspective view of a flow control device in accordance with one embodiment of the present disclosure.

FIG. 3B illustrates a front view of the flow control device of FIG. 3A.

FIG. 4A-4D illustrate use of a filtration container assembly in accordance with embodiments of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, to achieve the same or substantially similar result.

In the following description, numerous specific details are set forth to provide a thorough understanding of exemplary embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

Embodiments of the present disclosure are generally directed to filtration container assemblies and methods of use therefor. The filtration container assemblies and methods of the present disclosure can provide several advantages over conventional filtration assemblies and methods. For example, the filtration container assemblies of the present disclosure can filter a water source to provide clean, drinkable water through a quick and portable filtering process. In some examples, the filtration container assemblies described herein can include a flow control device that can prevent already filtered water from unintentionally flowing back through a filtration assembly. Including a flow control device within the filtration container assembly can protect the filtration assembly within the container and increase its lifespan. Furthermore, the flow control device can allow for desired impurities to be introduced into the filtered water. For instance, a user can use a filtration container assembly to filter a water source and, after the filtering process, introduce electrolytes or flavorings into the filtered water. The flow control device can ensure these electrolytes or other impurities remain within the filtered fluid and are not filtered out via the filtration assembly. Similarly, the filtration container assemblies described herein can be used to hold beverages besides water. For example, the filtration container assemblies can include a sleeve that can hold a beverage. This sleeve can be isolated from the filter via the flow control device, which ensures the beverage held within the sleeve is not unintentionally filtered. As a result of this arrangement, a user can use the filtration container assembly as a conventional cup or bottle when desired. These and other advantages of the filtration container assemblies and methods of use will be described in more detail herein.

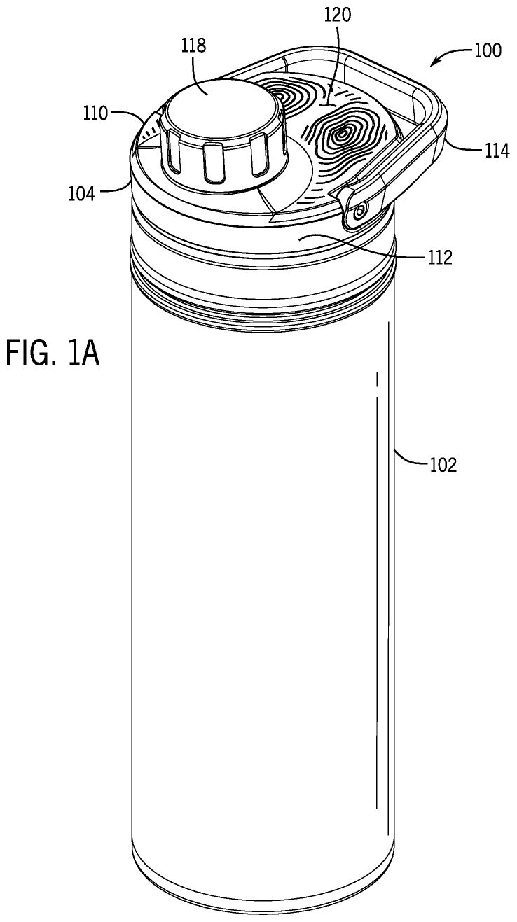

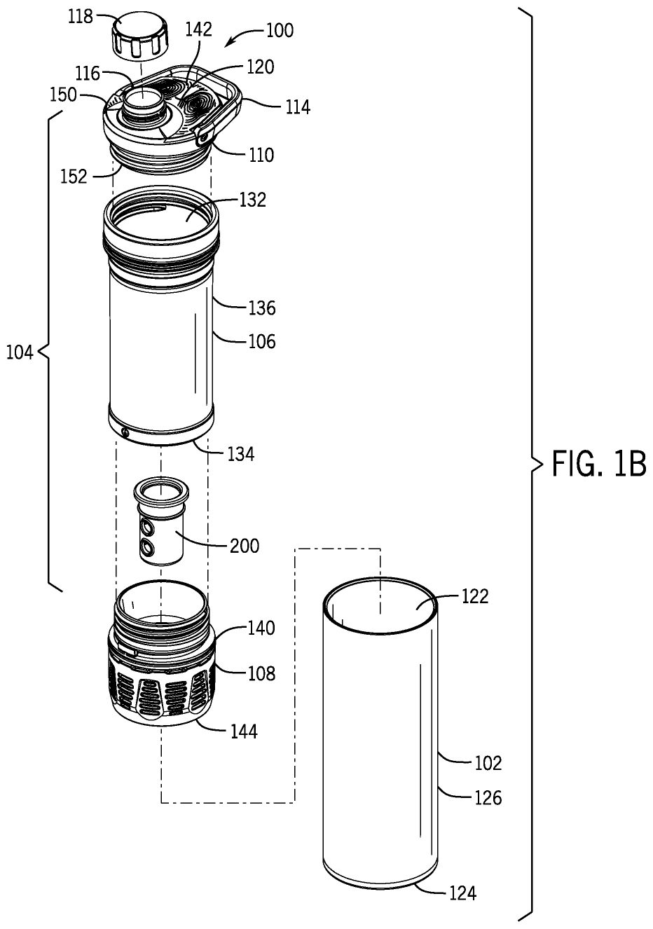

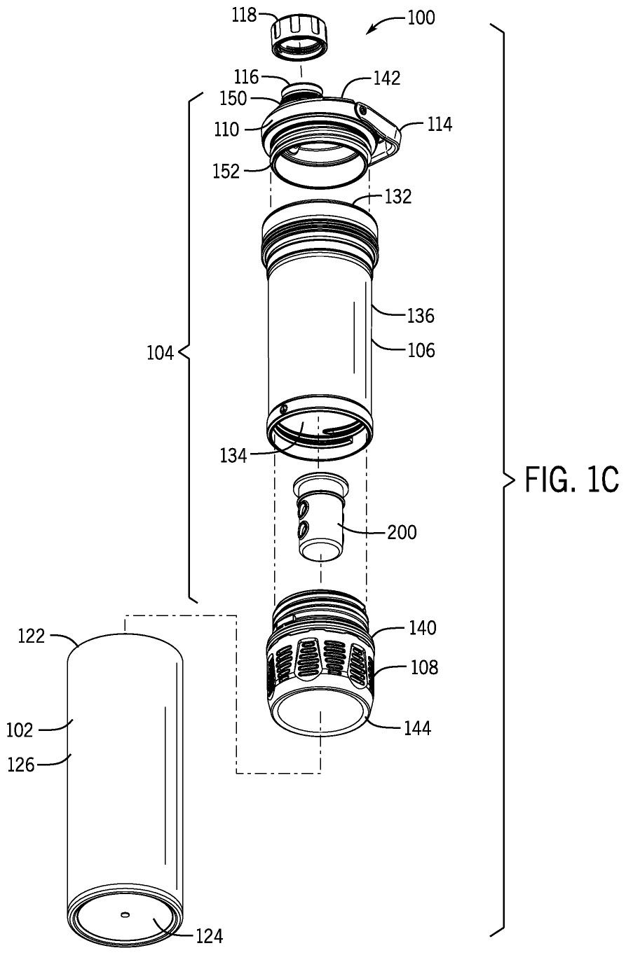

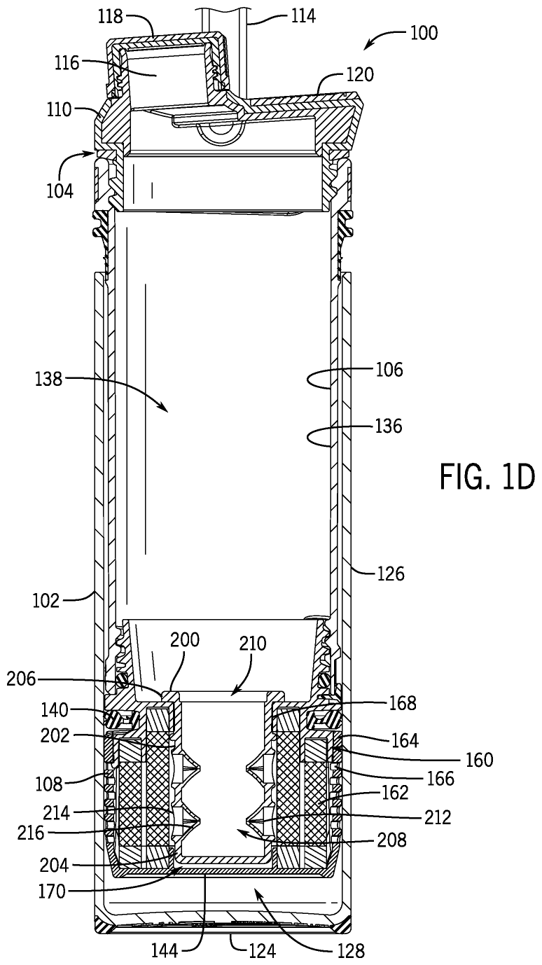

FIGS. 1A-1D illustrate several views of a filtration container assembly 100 which can be used to filter a fluid, such as water. As shown in FIGS. 1A-1D, the filtration container assembly 100 can generally include an outer container 102 and a plunging assembly 104, which includes an inner sleeve 106 and a filtration assembly 108 having a flow control device 200. As described in greater detail below, the outer container 102 can be at least partially filled with a fluid, and once partially filled, the user can exert positive pressure on the plunging assembly 104 to nest the plunging assembly 104 within the outer container 102. This positive pressure can displace the fluid within the outer container 102 and move the fluid through the filtration assembly 108 (and flow control device 200) and into the inner sleeve 106. The user can then access this filtered fluid held within the inner sleeve 106, for example, through a spout 116.

Although shown and described as a personal water filtration container assembly, it should be appreciated that other embodiments are within the scope of the present disclosure. For example, a filtration container assembly within the scope of the present disclosure may be configured as a large container, such as a jug, cooler, barrel, or tank, or as a smaller container, such as a bottle or sippy cup. It should be appreciated that larger form factors may use a crank or even an electric motor to achieve the positive pressure value required for filtration.

Moreover, coffee or tea presses having inner sleeves and outer containers, but which include screen or sieve filters instead of particulate and microbial filters, are within the scope of the present disclosure. In accordance with embodiments of the present disclosure, suitable filters for use in the filtration container assemblies, include, but are not limited to screens, sieve fillers, granular-activated carbon filters, metallic alloy filters, microporous ceramic filters, a carbon block resin filters, electrostatic nanofiber filters, reverse osmosis filters, ion exchange filters, UV light filters, hollow fiber membrane filters, and ultra-filtration membrane filters.

Referring to FIGS. 1B-1D, the outer container 102 will now be described. In the illustrated embodiment, the outer container 102 is a substantially cylindrical cup having a wall 126 extending between a first open end 122 and a second closed end 124 and defining an inner cavity 128. Although shown in the illustrated embodiment as having a substantially cylindrical wall 126 on both inner and outer surfaces, it should be appreciated that other cross-sectional shapes are also within the scope of the present disclosure. For example, the outer container 102 may have a substantially cylindrical inner cavity 128, but a non-cylindrical outer surface. As described in greater detail below, a substantially cylindrical inner cavity 128 is designed and configured to mate with a plunging assembly 104 in accordance with one embodiment of the present disclosure.

The outer container 102 is configured to receive fluid, for example, unpurified or unfiltered tap or water from a natural, untreated source. In that regard, when in use, the outer container 102 may be filled or at least partially filled with a fluid. The outer container 102 may be made from any suitable materials designed for holding a fluid, for example, suitable plastic and/or metal materials.

Still referring to FIGS. 1B-1D, the plunging assembly 104 will now be described. As mentioned above, the plunging assembly 104 includes the inner sleeve 106, the filtration assembly 108 (including the flow control device 200), all of which are designed to be received within the inner cavity 128 of the outer container 102. In the illustrated embodiment, the inner sleeve 106 has a wall 136 extending between a first open end 132 and a second open end 134 and defining an inner bore 138 therethrough. Therefore, the inner sleeve 106 has a continuous sidewall to prevent the migration of contaminants into the filtered fluid that is stored in the inner sleeve 106.

In the illustrated embodiment, the filtration assembly 108 has a first end 146 and a second end 148, with the first end 146 of the filtration assembly 108 disposed at or near the second open end 134 of the inner sleeve 106 and the second end 148 of the filtration assembly 108 defining the second end 144 of the plunging assembly 104. The first end 146 of the filtration assembly 108 may be mechanically coupled to the inner sleeve 106 at or near the second open end 134 of the inner sleeve 106. In the illustrated embodiment, the first end 146 of the filtration assembly 108 and the second end 134 of the inner sleeve 106 include reciprocal threads for a screw interface. However, other suitable interfaces are also within the scope of the present disclosure.

In the illustrated embodiment, the filtration assembly 108 is disposed outside the inner bore 138 of the inner sleeve 106. However, in some embodiments, the filtration assembly 108 may be all or partly disposed within the inner bore 138 of the inner sleeve 106.

As shown in FIG. 1D, the filtration assembly 108 can include a filter housing 160 disposed between the first end 146 and second end 148 of the filtration assembly 108. The filter housing 160 can be configured to receive a filter media 162 within. The filter media 162 which can be used to filter a fluid flowing through the filter media 162. In some embodiments, the filter media 162 can have a pleated design and can form a circular cross-section when disposed within the filter housing 160.

In the illustrated embodiment, the filter housing 160 includes an outer wall 164 at the radially outer portion of the filtration assembly 108. The outer wall 164 can define a fluid inlet for fluid to flow into (or out of) the filter media 162. For example, the outer wall 164 can include one or more apertures 166 formed within the outer wall 164, which provides a conduit for fluid to flow into the filter media 162 or out of the filtration assembly 108. The filter housing 160 can also include an inner wall 168 that is radially inward of the outer wall 164. The inner wall 168 can define a fluid outlet for fluid to flow out of (or into) the filter media 162, and in some examples, can include one or apertures formed within the inner wall 168. In some embodiments, the inner wall 168 can define a cavity 170 within the filtration assembly 108.

As illustrated in FIG. 1D, the cavity 170 can be formed at the radial center of the filtration assembly 108. Therefore, the flow of liquid through the filtration assembly 108 is radially inward from the one or more apertures 166 formed within the outer wall 164, through the filter media 162 disposed within the filtration assembly 108, and through the fluid outlet formed in the inner wall 168. Such radial fluid flow in a crosswise direction from pressing direction of the plunging assembly 104 into the outer container 102 can create directional and/or turbulent liquid flow through the filter media to optimize the filtering effect of the filtration assembly 108. However, other filtration designs are within the scope of the present disclosure.

In the illustrated embodiment, the inner wall 168 defines a cavity 170 with a circular cross-section. However, other cross-sectional shapes for the cavity 170 are within the scope of the present disclosure.

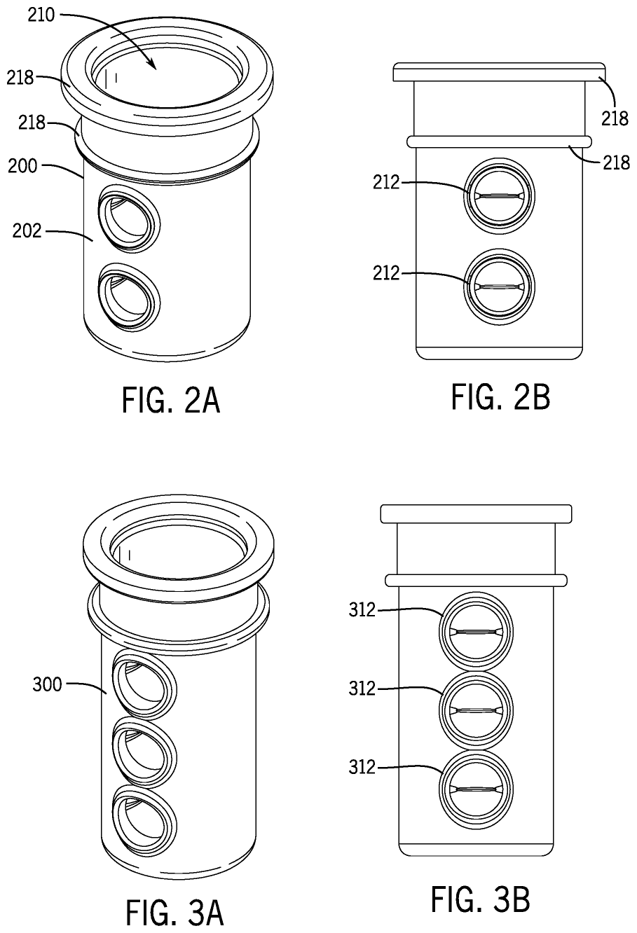

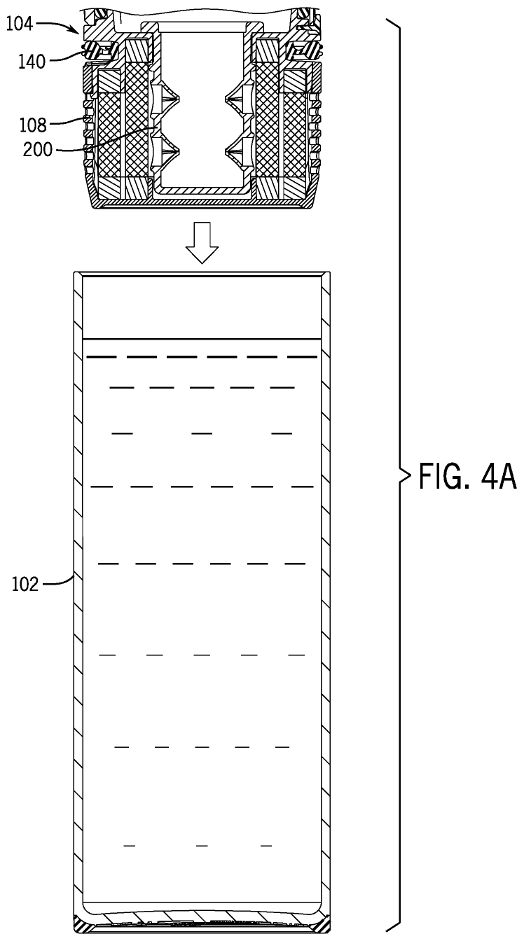

As shown in FIGS. 1B-1D, the plunging assembly 104 can include a flow control device 200. The flow control device 200 can control the flow of fluid between the filtration assembly 108 and the inner sleeve 106. In the illustrated embodiment of FIGS. 1B-1D and 2A-2B, the flow control device 200 can include a body 202 having a first end portion 204 and a second end portion 206 opposite the first end portion 204. The body 202 can have a hollowed profile that defines an inner cavity 208 and can include an aperture 210 formed at one or more ends of the body 202 (e.g., at the first and/or second end portions 204, 206). One or more valves 212 can be formed within the body 202, with the valves 212 forming a passageway through the body 202. The valves 212 can include an inlet 214 and an outlet 216 on either end of this passageway.

The valves 212 can be configured to control the flow of fluid through the flow control device 200. In some embodiments, the valves 212 can limit the direction that the fluid can flow through the flow control device 200. For example, the valves 212 can be configured as a check valve (e.g., a one-way valve) that permits fluid to flow radially inward from the inlet 214, through the outlet 216 and into the inner cavity 208, but limits fluid from flowing in the opposite direction (e.g., from flowing radially outward from the outlet 216, through the inlet 214, and into the filtration assembly 108). By limiting what direction the fluid can flow, the flow control device 200 can limit or prevent any backflow of fluid held within the inner sleeve 106 (e.g., the flow control device 200 can prevent the already filtered fluid from flowing through the filter media 162 a second time). The valves 212 can also control the rate of flow of the fluid through the flow control device 200 and can be adjusted accordingly to achieve the desired flow rate at a given fluid velocity. For example, the number or sizing of valves 212 formed on the body 202 can be adjusted to increase or decrease the overall flow rate of fluid through the flow control device 200. In some examples, the flow rate can be designed to work together with the flow rate imparted through the filtration assembly 108 by the user imparting pressure to the plunging assembly 104 disposed within the outer container 102. In other examples, the flow rate can be designed to restrict (e.g., reduce or slow) the flow of fluid through the flow control device 200.

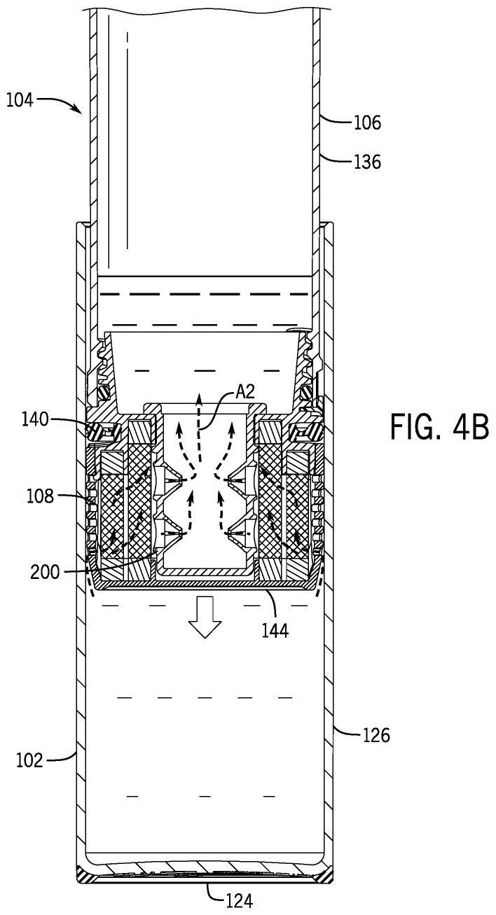

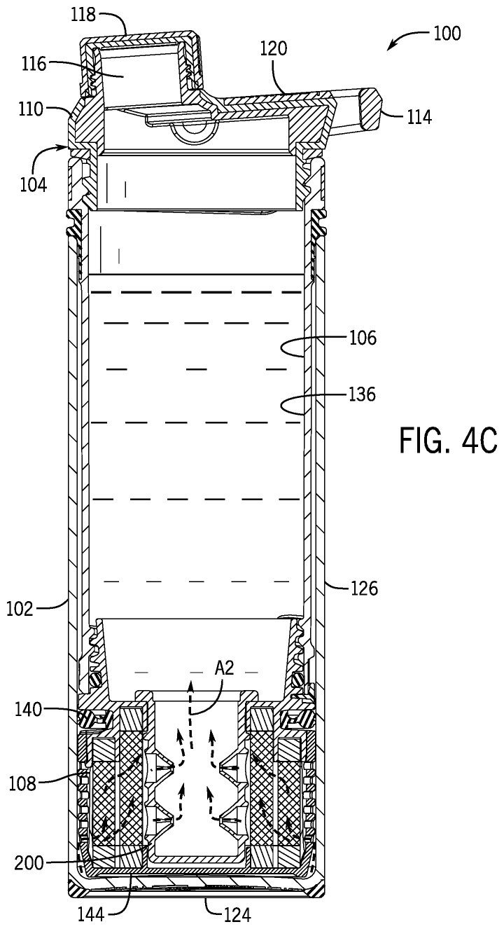

In the illustrated embodiment, the flow control device 200 can include eight valves 212 formed around the body 202. In another embodiment (e.g., as illustrated in FIGS. 3A and 3B), a flow control device 300 is provided, which includes twelve valves 312 positioned around the flow control device 300. Other amounts of valves 212 can be formed on the flow control device 200. In some embodiments, the positioning and size of the valves 212 can be adjusted to change or optimize the flow rate based on design factors, including but not limited to, the size of the outer container 102, the volume of liquid being filters, and/or the design of the filtration assembly 108. For example, the valves 212 can be positioned in aligned pairs (e.g., one valve 212 can be positioned adjacent a second valve 212), as shown in the illustrated embodiment. In other examples, the valves 212 can be arranged in a different pattern, including, for instance, a staggered pattern.

In the illustrated embodiments, the valves 212 are duckbill valves. While the embodiments herein illustrate the valves 212 as duckbill valves, other valves are within the scope of the disclosure. For example, the valves 212 can take the form of a crosscut valve, an umbrella valve, a ball check valve, a diaphragm check valve, or a combination of different valves. In the illustrated embodiment, the valves 212 are one-way valves. In some embodiments, the valves may permit fluid to flow in either direction.

In some examples, the flow control device 200 is formed from a single piece of material. In some of these examples, or otherwise, the flow control device 200 can be made from any suitable materials, including, for example, plastics, metals, and silicon. In various examples, the flow control device 200 is formed from more than one material. For instance, the body 202 of the flow control device 200 may be formed from a first material while the valves 212 are formed from a second material different from the first material. In one embodiment, the flow control device 200 may be made from a malleable silicon that can be disposed within and removable from the outlet of the filtration assembly 108. Removing the flow control device 200 from the filtration assembly 108 allows for the flow control device 200 to be easily cleaned or replaced.

Although shown and described as separable, the flow control device 200 may be integrally formed with or non-removable from the filtration assembly 108. For example, the flow control device 200 can be integrally formed with the inner wall 168 of the filter housing 160.

As shown in FIGS. 1B-1D, the flow control device 200 can be received within the cavity 170 of the filtration assembly 108. In the illustrated embodiment, the flow control device 200 is coupled at or near the outlet defined by the inner wall 168 of the filtration assembly 108. In this configuration, at least a portion of the flow control device 200 can conform to the profile of the cavity 170. For example, the body 202 of the flow control device 200 can be adjacent (or coupled to) the inner wall 168 of the filter housing 160. Additionally, or alternatively, the first end portion 204 of the flow control device 200 can be adjacent (or coupled to) the second end 148 of the filtration assembly 108. Positioning the flow control device 200 in this manner can greatly limit any dead space (e.g., space that is unable to hold a filtered fluid) between the flow control device 200 and the filtration assembly 108, which in turn maximizes the volume of the inner sleeve 106.

In some embodiments, the flow control device 200 can form a seal with the filtration assembly 108. For example, the flow control device 200 can include one or more sealing portions 218 (as shown in FIGS. 2A and 2B) which can couple with the inner wall 168 to form a seal with the filtration assembly 108. Because a seal is formed with the filtration assembly 108, any fluid flowing into the inner cavity 106 via the filtration assembly 108 must flow through the valves 212 on the flow control device 200. Similarly, this seal can prevent any fluid flowing from the inner cavity 106 to the outer container 102 without first flowing through the valves 212. Accordingly, the seal can prevent a fluid from circumventing the valves 212 on the flow control device 200.

The flow rate of fluid through the flow control device 200 (e.g., the combined amount of fluid that can flow through each valve 212 on the flow control device 200 at a given velocity) can be configured to substantially match the flow rate of fluid through the filtration assembly 108. Stated differently, the flow control device 200 can be configured so that fluid flowing through the flow control device 200 does not bottleneck the filtration process. In some embodiments, the ratio of the flow rate of the flow control device 200 to the flow rate of the filtration assembly 108 can be 1:1, 1.25:1. 1.5:1. 1.75:1. 2:1, 2.5:1, 5:1, 10:1, or other ratio.

In some embodiments, the flow rate of fluid through the flow control device 200 can be configured to restrict the flow rate of fluid through the filtration assembly 108. Stated differently, the flow control device 200 can be configured so that fluid flowing through the flow control device 200 bottlenecks the filtration process. In some examples, the ratio of the flow rate of the filtration assembly 108 to the flow rate of the flow control device 200 can be 1:1, 1.25:1. 1.5:1. 1.75:1. 2:1, 2.5:1, 5:1, 10:1, or other ratio

Referring again to the plunging assembly 104, this plunging assembly 104 is configured to move like a piston relative to outer container 102, and therefore, is designed to be received within the outer container 102. Although not required, the inner sleeve 106 may have a substantially consistent cross-sectional area and/or shape along the length of inner sleeve 106. Although shown as a substantially cylindrical outer container 102, it should be appreciated that the outer container 102 may be configured to have any cross-sectional shape, so long as the inner cavity 128 of the outer container 102 and the outer wall 136 of the inner sleeve 106 are capable of nesting together. In one embodiment of the present disclosure, when nested, the inner sleeve 106, the filtration assembly 108, and the flow control device 200 are wholly contained within the inner cavity 128 of the outer container 102. In the illustrated embodiment, the inner cavity 128 of the outer container 102 is substantially cylindrical, and the second end 144 (the plunging end) of the plunging assembly 104 is configured to form a seal with the inner cavity 128 of the outer container 102 through the piston movement of the plunging assembly 104 (compare FIGS. 3A-3D).

The plunging assembly 104 of the illustrated embodiment further includes a cap assembly 110 at its first end 142 (the gripping end) of the plunging assembly 104. Referring to FIGS. 1A-1D, the cap assembly 110 includes a body portion 112, an optional handle 114, and an access port or spout 116. The access port or spout 116 provides access to the inner bore 138 of the inner sleeve 106, for example, for a user to drink from or to pour from. In the illustrated embodiment, the spout 116 includes a spout cap 118.

The body portion 112 of the cap assembly 110 has a first end 150 and a second end 152 defining a cap body height. In the illustrated embodiment, the spout 116 is located at the first end 150 of the cap assembly 110, and the second end 152 of the cap assembly 110 is configured for interfacing with the first end 132 of the inner sleeve 106. In the illustrated embodiment, the cap assembly 110 and the first end 132 of the inner sleeve 106 include reciprocal threads for a screw interface. However, other suitable interfaces are also within the scope of the present disclosure.

The body portion 112 further defines a pressing surface 120 (see FIG. 1A) that can be used to press the plunging assembly 104 into the outer container 102. The pressing surface 120 allows for a compression force to be applied by a user to press the plunging assembly 104 into the inner cavity 128 of the outer container 102 along a longitudinal axis of the outer container 102. The second closed end 124 of the outer container 102 defines a second pressing surface upon which the compression force can the applied. For example, the second closed end 124 may be held by the user of positioned on a surface when the user presses on the first pressing surface 120. The body portion 112 or the handle 114 of the cap assembly 110 can be used to withdraw the plunging assembly 104 from the outer container 102.

The handle 114 may be a pivoting handle that can move between an extended position and a retracted position. When the handle 114 is in the extended position, it can be used for carrying the filtration container assembly 100 or for pulling the plunging assembly 104 from the outer container 102. When the handle 114 is in the retracted position, the pressing surface 120 of the cap body portion 112 along with the sides of the handle 114 can be used together define an enhanced (larger) pressing surface configured for a user to press the plunging assembly 104 into the inner cavity 128 of the outer container 102. A large pressing surface 120 allows for ease of use for the user.

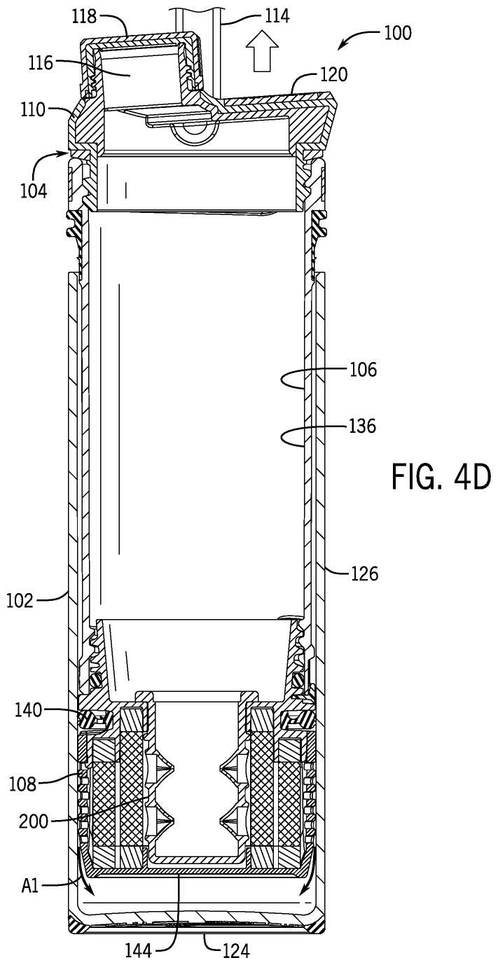

Use of the filtration container assembly 100 will now be described, in greater detail with reference to FIGS. 4A-4D. As can be seen in FIGS. 4A-4D, the outer container 102 and the plunging assembly 104 are capable of nesting with one another. In that regard, the second end 144 of the plunging assembly 104 seats at the bottom of the inner cavity 128 of the outer container 102, with a sealing device 140 forming a seal with the inner wall 126 of the outer container 102. Optional guides structures may extend from the outer wall 136 of the inner sleeve 106, from the filtration assembly 108, or from the inner wall 126 of the outer container 102 to provide suitable spacing between the plunging assembly 104 and the outer container 102. A collar assembly may be included at the interface between the first end 122 of the outer container 102 and the first end 132 of the inner sleeve 106 to engage the outer container 102 and the plunging assembly 104 and to optionally form a seal therebetween, for example, to prevent fluid spillage.

Referring to FIG. 4A, when the plunging assembly 104 is removed from the outer container 102, the outer container 102 can be filled with fluid. Referring to FIGS. 4B and 4C, as the plunging assembly 104 is pressed by the user into the outer container 102, it filters fluid (such as water) from the outer container 102 as it passes through the filtration assembly 108 and flow control device 200 and into the inner sleeve 106. The filtered fluid is then stored in the inner sleeve 106.

In some embodiments, the flow control device 200 can be configured to control the direction fluid can flow so as to ensure the filtered fluid remains stored in the inner sleeve 106. Accordingly, once the fluid flows through the flow control device 200 and into the inner sleeve 106, the valves 212 on the flow control device 200 can restrict the filtered fluid from flowing back through the filtration assembly 108. This arrangement can protect the filtration assembly 108 and increase its lifespan.

Referring to FIG. 4C, when the plunging assembly 104 is fully inserted in the outer container 102, the plunging assembly 104 in nested within the outer container 102. After the plunging assembly 104 is fully inserted into the outer container 102, impurities can be added into the filtered fluid, if desired. For example, the cap assembly 110 can be removed and impurities (e.g., electrolytes, flavorings, etc.) can be added directly into the filtered fluid. When the flow control device 200 is configured to restrict fluid from unintentionally flowing back through the flow control device 200, the impurities added into the filtered fluid will remain within the fluid and will not be filtered out of the fluid by the filtration assembly 108.

Referring to FIG. 4D, after the water or other fluid has been removed from the inner sleeve 106, the plunging assembly 104 may be removed from the outer container 102 so that the outer container 102 can be refilled and reused for filtering. To release the plunging assembly 104 from the outer container 102, the user simultaneously grasps the outer container 102 with one hand and the plunging assembly 104 with the other hand, releasing the coupling of the plunging assembly 104 and the outer container 102.

As can be seen in comparing FIGS. 4A and 4D, the sealing device 140 is a “floating” seal, which means it is capable of movement between first and second “up” and “down” positions. In FIG. 4D, as the plunging assembly 104 is released from the outer container 102, the sealing device 140 of the filtration assembly 108 moves to the “down” position, creating a pathway for air or liquid to release the pressure in the outer container 102, as shown by the arrows A1.

Referring now to FIG. 4A, with the plunging assembly 104 removed from the outer container 102, the outer container 102 can be filled with fluid. Referring now to FIG. 4B, after the outer container 102 has been filled with fluid, the plunging assembly 104 can be reinserted into the outer container 102 to filter the fluid and store it in the inner bore 138 of the inner sleeve 106. As can be seen in FIG. 4B, when filtering, the sealing mechanism 140 of the filtration assembly 108 moves to the “up” position, creating a seal between the outer container 102 and the inner sleeve 106, forcing all water in the outer container 102 through the filtration assembly 108 and flow control device 200 and into the inner bore 138 of the inner sleeve 106, as shown by the arrows A2.

Although the filtration container assembly 100 of the present disclosure is shown and described as using a floating seal for pressure release, it should be appreciated that other methods of pressure release are also within the scope of the present disclosure.

Any directional references in the present application, such as “up”, “down”, “top”, “bottom”, etc., are intended to describe the embodiments of the present disclosure with reference to the orientations provided in the figures and are not intended to be limiting. Where appropriate, relative terms, such as “about,” “substantially,” and “approximately,” can be understood to incorporate standard engineering and/or manufacturing tolerances. For example, two members that are “substantially parallel” may be understood to mean two members that are parallel within standard engineering tolerances.

Other technical features may be readily apparent to one skilled in the art from the following figures, descriptions, and claims. While illustrative embodiments have been illustrated and described, it will be appreciated that various changes can be made therein without departing from the spirit and scope of the disclosure.

What is claimed is:

1. A filtration container assembly, the assembly comprising:
an outer container having a first open end and a second closed end and defining an inner cavity; and
a plunging assembly having a first end and a second end, wherein the second end of the plunging assembly is configured to be received within the inner cavity of the outer container, wherein the plunging assembly includes an inner sleeve having a first end and a second end and an outer wall defining an inner bore, and a filtration assembly in fluid communication with the inner bore, the filtration assembly including a flow control device at or near an outlet of the filtration assembly.

2. The filtration container assembly of claim 1, wherein the outer wall is continuous from the first end to the second end of the inner sleeve.

3. The filtration container assembly of claim 1, wherein the filtration assembly includes a first end and a second end, wherein the first end of the filtration assembly is at or near the second end of the inner sleeve.

4. The filtration container assembly of claim 3, wherein the first end of the filtration assembly is mechanically coupled to the inner sleeve at or near the second end of the inner sleeve.

5. The filtration container assembly of claim 3, wherein the second end of the filtration assembly is outside the inner bore of the inner sleeve.

6. The filtration container assembly of claim 3, wherein the plunging assembly is configured to filter a liquid contained in the outer container as the plunging assembly is pressed into the inner cavity of the outer container and the liquid moves from the inner cavity of the outer container through the filtration assembly to the inner bore of the inner sleeve of the plunging assembly.

7. The filtration container assembly of claim 3, wherein the filtration assembly defines a filter housing between the first and second ends of the filtration assembly, the filter housing having a first wall defining a fluid inlet and a second wall defining a fluid outlet.

8. The filtration container assembly of claim 7, wherein the first wall includes a plurality of apertures defining the fluid inlet.

9. The filtration container assembly of claim 7, wherein filter media is disposed within the filter housing.

10. The filtration container assembly of claim 9, wherein the filter media has a circular cross-section, and wherein the first wall is an outer wall and the second wall is an inner wall.

11. The filtration container assembly of claim 10, wherein liquid is configured to flow from the inlet through the filter media to a cavity of the filtration assembly.

12. The filtration container assembly of claim 10, wherein the inner wall defines a cavity within the filtration assembly.

13. The filtration container assembly of claim 12, wherein the cavity is defined at the radial center of the filtration assembly.

14. The filtration container assembly of claim 12, wherein the flow control device is disposed within the cavity.

15. The filtration container assembly of claim 14, wherein the flow control device is configured to restrict liquid held within the inner bore from flowing through the filtration assembly.

16. The filtration container assembly of claim 14, wherein the flow control device includes one or more sealing portions, the one or more sealing portions configured to couple to the filter housing and form a seal between the flow control device and the filter housing.

17. The filtration container assembly of claim 14, wherein at least a portion of the flow control device contacts the inner wall of the filter housing.

18. The filtration container assembly of claim 17, wherein the flow control device includes an end portion, and wherein the end portion is coupled to the second end of the filtration assembly.

19. A filter assembly for a filtration container assembly, comprising,
a filter housing having a first wall and a second wall radially inward of the first wall, the second wall defining a cavity at the center of the filter assembly;
a filter media disposed within the housing, the filter media being configured to filter a fluid flowing through the filter media, wherein, at a first pressure, the fluid will flow through the filter media at a first flow rate; and
a flow control device coupled to the filter housing such that the flow control device is disposed within the cavity defined by the inner wall of the filter housing, wherein the flow control device is configured to limit the direction the fluid can flow, wherein, at the first pressure, the fluid can flow through the flow control device at a second flow rate, and wherein the second flow rate is substantially equal to, or greater than, the first flow rate.

20. A method of filtering a liquid using a filtration container assembly, the method comprising:
obtaining a filtration container assembly including an outer container having a first open end and a second closed end and defining an inner cavity, and a plunging assembly having a first end and a second end, wherein the second end of the plunging assembly is configured to be received within the inner cavity of the outer container, wherein the first end of the plunging assembly includes a cap having a pressing surface configured for a user to press the plunging assembly into the inner cavity of the outer container, and wherein the plunging assembly includes a filtration assembly having a flow control device disposed within a cavity within the filtration assembly;
filling the outer container with a liquid to equal to or less than a fill indicator;
inserting the second end of the plunging assembly into the first open end of the outer container; and
pressing the first pressing surface of the plunging assembly to press the plunging assembly into the inner cavity of the outer container.
